(19) United States
(12) Patent Application Publication
(10) Pub. No.: US 2012/0254915 A1
(43) Pub. Date: Oct. 4, 2012

(54) TRANSITION FROM LOCALLY STORED VIDEO DATA TO BROADCAST FEED

(75) Inventor: Ant Oztaskent, Sutton (GB)

(73) Assignee: GOOGLE INC., Mountain View, CA (US)

(21) Appl. No.: 13/076,043

(22) Filed: Mar. 30, 2011

(51) Int. Cl. H04N 7/10

(52) U.S. Cl. 725/35; 725/32

(57) ABSTRACT

Methods, systems, and apparatus, including computer programs encoded on a computer storage medium, for television advertising. In one aspect, a method includes generating a first video signal from a broadcast feed and providing the first video signal for display on a television device. Selecting advertisement data for an advertisement in response to a signal in the broadcast feed indicating the broadcast contains a replaceable portion. Generating a first video signal from the selected advertisement data. In response to generating the first video signal from the ending segment of the advertisement data, generating a second video signal from the broadcast feed while continuing to generate the first video signal from the ending segment of the advertisement data. Providing the second video signal for display on the television device after generating the first video signal from the advertisement data is complete.

### BACKGROUND

This specification relates to video processing.

Addressable advertisements are advertisements that are selectively displayed to groups of viewers based on viewer demographics. In general, advertisers select the demographics of the groups they want to target with addressable advertisements, and viewing devices associated with the selected demographics are identifies. An example viewing device is a set top box, a satellite decoder, or other television processing devices that receive broadcast signals and decode the signals for viewing on a display device. The television provider, based on subscription information, viewer behavior, and other information, know the demographics associated with each viewing device. Once the viewing devices associated with a particular demographic are identified, targeted television advertisements are sent to the viewing device for storage for later presentation.

The broadcast feed includes portions that are “replaceable,” i.e., data that can be replaced with the advertisements that are stored locally at a television processing device. The replaceable portion can be another advertisement, or even a portion of a broadcast for which not content is provided. The replaceable portion is marked as such with metadata, or some other data or signal in the broadcast.

When a viewing device encounters a broadcast portion marked as “replaceable,” the viewing device selects one of the previously distributed addressable advertisements. The viewing device generates a video signal from the addressable advertisement and outputs the video signal to the television display device, causing the television display device to display the addressable advertisement instead of replaceable portion of the broadcast.

Broadcast feeds are typically compressed. The viewing device decodes the broadcast feed, generating a video signal displayable upon a television. To decode the broadcast feed, the viewing device synchronizes to the broadcast feed using a codec. The broadcast feed periodically contains special segments (key frames) enabling the viewing device to synchronize. Key frames are transmitted approximately every 0.5 seconds for standard-definition broadcast feeds and approximately every two seconds for high-definition broadcast feeds. These times may vary, depending on the compression technique used, and the amount of data being decoded.

Addressable advertisements are also compressed according to the same compression technique used to compress the broadcast feed. The viewing device replaces replaceable portion of the broadcast feed by decoding the addressable advertisement and generating the video signal from the decoded addressable advertisement. Switching from the decoding of the broadcast feed to the decoding of the compressed addressable advertisement causes the viewing device to lose synchronization with the broadcast feed. However, because the addressable advertisement is stored with key frames, the view typically will not notice this loss of synchronization when the advertisement begins to be displayed. After processing and displaying the addressable advertisement, however, the viewing device must receive the next key frame on the broadcast feed before it can decode and provide a video signal for displaying the broadcast feed. This causes the television display device to display a blank screen or a frozen last frame of the addressable advertisement upon completion of the addressable advertisement. The blank screen or frozen last frame of the addressable ad lasts until the viewing device receives a new key frame in the broadcast feed, decodes the broadcast feed, and generates the video signal from the decoded data. Displaying a blank or frozen screen to the viewer for approximately one-half to several seconds or more can degrade the viewing experience for the viewer.

### SUMMARY

This specification describes technologies relating to systems and methods for television advertising. In general, one innovative aspect of the subject matter described in this specification can be embodied in methods that include the actions of generating a first video signal from a broadcast feed; providing the first video signal for display on a television display device; receiving a signal in the broadcast feed indicating the broadcast feed contains a replaceable portion; in response to receiving the signal: selecting, from a data storage device, advertisement data for an advertisement, the advertisement data including a beginning segment of compressed video data and an ending segment of uncompressed video data; generating the first video signal from the advertisement data for the advertisement; monitoring for generation of the first video signal from the ending segment of the advertisement data; in response to monitoring the generation of the first video signal from the ending segment of the advertisement data: generating a second video signal from a broadcast feed while generating the first video signal from the ending segment of the advertisement data; and providing the second video signal for display on the television display device after generating the first video signal from the advertisement data is completed.

These and other embodiments can each optionally include one or more of the following features. Receiving compressed data for the advertisement, the compressed data received in the broadcast feed; selecting a first segment of the compressed data and a second segment of the compressed data, the second segment of the compressed data being data that are used to generate an ending portion of the advertisement that is of a duration at least equal to a key frame periodicity of an encoding scheme used to encode the compressed data; decompressing the compressed data of the ending segment; storing the compressed data of the first segment as the beginning segment; and storing the decompressed data of the second segment as the ending segment.

In general, another aspect of the subject matter described in this specification can be embodied in methods that include the actions of receiving compressed data for the advertisement; selecting a first segment of the compressed data and a second segment of the compressed data, the second segment of the compressed data being data that are used to generate an ending portion of the advertisement that is of a duration at least equal to a key frame periodicity of an encoding scheme used to encode the compressed data; decompressing the compressed data of the ending segment; storing the compressed data of the first segment as a beginning segment of advertisement data; and storing the decompressed data of the second segment as an ending segment of advertisement data.

These and other embodiments can each optionally include one or more of the following features. Providing the advertisement data to a plurality of viewing devices; and transmitting a broadcast feed including a signal indicating the broadcast feed contains a replaceable portion that can be replaced by an advertisement generated from the advertisement data.

In an implementation, a viewing device includes a data storage device storing advertisement data for one or more advertisements, and for each advertisement the advertisement data includes a beginning segment and an ending segment; and signal processing circuitry in data communication with the data storage device and that performs operations comprising: generating a first video signal from a broadcast feed; providing the first video signal for display on a television display device; receiving a signal in the broadcast feed indicating the broadcast feed contains a replaceable portion; in response to receiving the signal: selecting, from a data storage device, advertisement data for an advertisement, the advertisement data including a beginning segment of compressed video data and an ending segment of uncompressed video data; generating the first video signal from the advertisement data for the advertisement; monitoring for generation of the first video signal from the ending segment of the advertisement data; in response to monitoring the generation of the first video signal from the ending segment of the advertisement data: generating a second video signal from a broadcast feed while generating the first video signal from the ending segment of the advertisement data; and providing the second video signal for display on the television display device after generating the first video signal from the advertisement data is completed.

Particular embodiments of the subject matter described in this specification can be implemented so as to realize one or more of the following advantages. By providing a smooth transition from an addressable advertisement back to a broadcast feed, the addressable advertisements are less distinguishable from standard advertisements or other portions of a broadcast feed. The overall viewing experience thus has fewer distractions than if blank content or a frozen frame were displayed, and the viewer experience with addressable advertisements is improved. Furthermore, by using only one decoder, the cost to implement the transitioning functionality is limited to firmware changes, and hardware changes are not required. The implementation is also compatible with a viewing device capable of receiving advertising data in response to the viewing device's request for advertisement data. Additionally, the implementation is backwards compatible with existing television display devices, which further reduces implementation costs.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example addressable television advertisement system.

FIG. 2 is a block diagram of example of a viewing device that generates a video signal for a broadcast feed or an addressable advertisement.

FIG. 3 is a flow chart diagram of an example process for transitioning from an addressable advertisement to a broadcast feed.

FIG. 4 is a flow chart of an example process for providing addressable advertisement data to a viewing device.

FIG. 5 is a flow chart of another example process for providing addressable advertisement data to a viewing device.

Like reference numbers and designations in the various drawings indicate like elements.

### DETAILED DESCRIPTION

Data of addressable advertisements are stored in the memory of a viewing device that decodes and generates a video signal from a compressed broadcast feed. The viewing device searches for indications of replaceable portions in the broadcast feed. A replaceable portion of a broadcast feed is a portion of the received broadcast feed that can be replaced with video from data stored locally at the viewing device. The replaceable potion may be defined in time length, e.g., a 30-second block, or may be defined from a starting point without a predefined time length, e.g., at time T the viewing device can begin generating video data from locally stored data. In response to receiving a signal indicating a replaceable portion in the broadcast feed, the viewing device selects an addressable advertisement from the memory and decodes and generates a video signal for the addressable advertisement. The viewing device, while generating the video signal for an addressable advertisement, monitors for generating the video signal from an ending segment of the addressable advertisement data. The ending segment is not compressed, and thus the viewing device does not require the codec resources to generate the video signal from the ending segment. Upon generating the video signal from the ending segment of the addressable advertisement data, the viewing device uses the codec resources to resume processing of the broadcast feed. The viewing device also continues to generate video signal from the ending segment, and during this time, the codec receives a key frame in the broadcast feed, enabling decoding of the broadcast stream. Upon completion of the addressable advertisement, the viewing device provides a video signal generated from the broadcast feed, enabling a transition from the addressable advertisement to the broadcast feed in which the occurrence of a blank screen or frozen frame is minimized or eliminated.

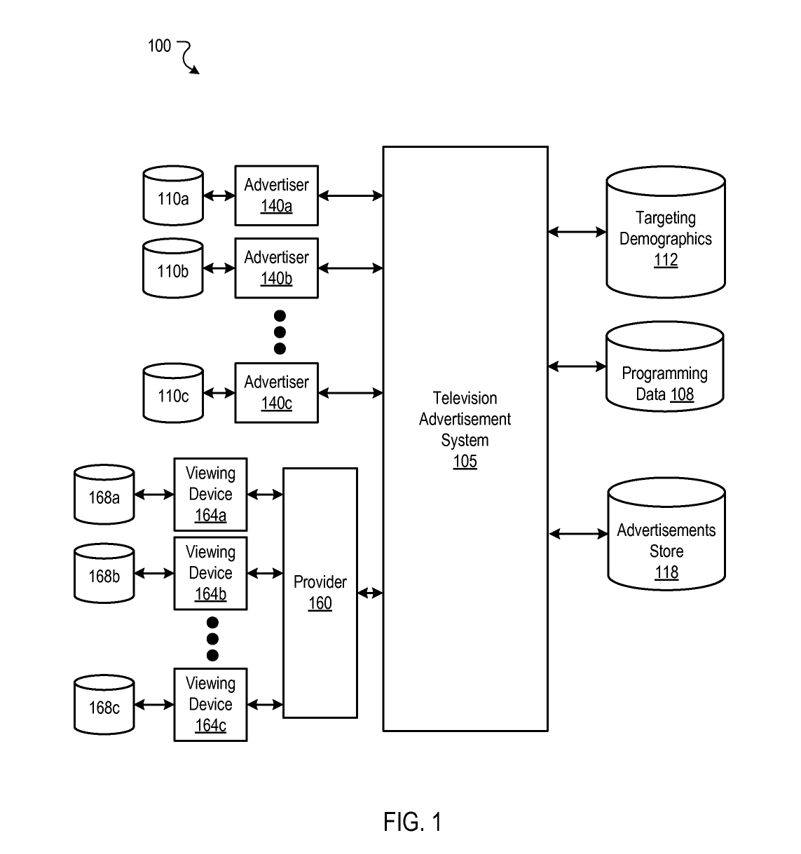

FIG. 1 is a block diagram 100 of an example television advertisement system 105 with addressable advertisements. The television advertisement system 105 includes advertisers 140 that provide advertisements and purchase advertising spots, viewing devices 164 that decode broadcast feed and supply video signal to television display devices, and a provider 160 that provides a broadcast feed to the viewing devices 164.

The television advertising system 105 can be implemented on one or more computer servers, and can provide and receive data over a network. Example networks include local area networks (LANs), wide area networks (WANs), telephonic networks, and wireless networks. Additionally, the television advertising system 105 can communicate over several different types of networks, e.g., the Internet, a satellite network, and a telephonic network.

The television advertising system 105 receives television advertisement 102 from advertisers 140, e.g., entities that provide television advertisements. The television advertising system 105 can facilitate the provisioning of customized television advertisements to a television provider 160, e.g., an entity that facilitates the delivery of a television broadcast to viewers, such as a cable provider, or a digital satellite provider.

A portion of the advertisements that the television advertising system 105 receives can be addressable advertisements. An addressable advertisement is an advertisement targeted for display to a specific demographic group of viewers. The television advertising system 105 will also receive targeting demographic information 110 from advertisers 140 for the addressable advertisements, e.g., the demographic characteristics of the viewers to be targeted for the addressable advertisements. An example of an addressable advertisement is an advertisement for a local restaurant intended to be viewed by those viewers within a specific local and of a specific income bracket.

Advertisers can also include what types of content they want their addressable advertisements inserted in, how frequently the addressable advertisements may be seen, what proximity to other advertisements the addressable advertisements can have, preferred presentation time range, and the like. In some implementations, the addressable advertisement system 105 stores the addressable advertisements in the addressable advertisements store 118. The targeting demographic information 102 is stored in the targeting demographics 112.

The provider 160 provides replaceable portion availability schedules to the addressable advertising system 105, which, in turn, stores the availabilities in the programming data 108, along with other data describing advertising spot availabilities.

For addressable advertisements, the television advertising system 105 accesses the targeting demographics and demographic data associated with the viewing devices to select advertisements to be provided to the viewing devices 164. The advertisements and identifiers that identify viewing devices 164 and the advertisements they are to receive are provided to the provider 160, which then, in turn, distributes the advertisements to the respective viewing devices 164. Alternatively, the television advertising system 105 can provide the advertisements and targeting demographics to the provider 160, which then, in turn, distributes the advertisements and targeting demographics to the viewing devices 164. In some implementations, the provider distributes the advertisements to a viewing device 164 in response to a request from the viewing device for advertisements. For example, in some implementations a viewing device 164 can request and receive advertisements over an Internet Protocol network. Each viewing device 164 then stores the advertisements it receives in a memory storage device 168.

As will be described in more detail below, when the broadcast feed of the provider indicates a replaceable portion, each viewing device 164 can select an addressable advertisement, decode the advertisement and provide the advertisement for display on a display device.

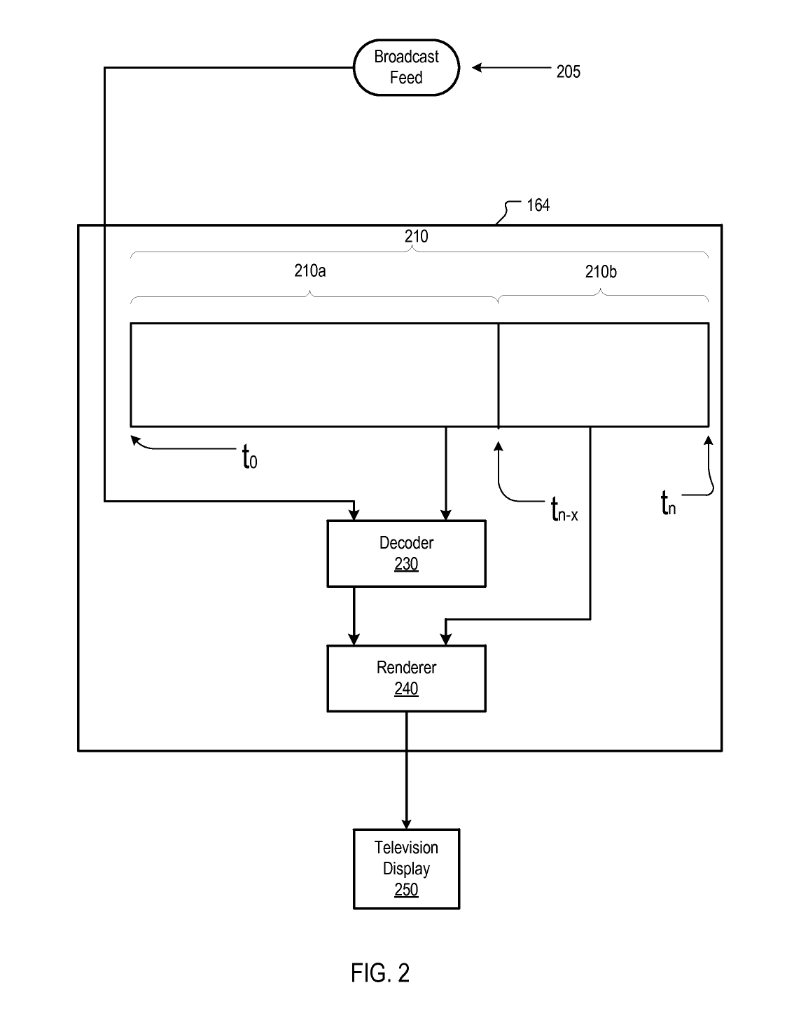

FIG. 2 is a block diagram of example of a viewing device 164 that generates a video signal for a broadcast feed or an addressable advertisement. The rendered video signal is displayed on a television viewing display 250.

The viewing device 164 receives a broadcast feed 205. As previously described, the broadcast feed is compressed data (e.g., an I-frame in an MPEG-2, etc.) and periodically includes a key frame. The viewing device 164 uses a decoder 230, e.g., a codec that uses the key frame to decompress the broadcast feed 205. The decompressed broadcast feed 405 (decompressed video data) is provided to the renderer 240, e.g., a video buffer. The renderer 440, in turn, provides the video signal for display on the television device 250.

When the viewing device 164 receives the signal indicating a replaceable portion in the broadcast feed 204, the viewing device selects advertisement data 210 for generating a video signal for display on the television device 250. The first segment 410a of the advertisement data is compressed video data, which is used to generate the video signal for the advertisement from the time t₀ to tₙ₋ₓ. Data from the first segment 410a is decompressed by the decoder 230 and provided to the renderer 240.

The ending segment 210b of the advertisement data 210 is uncompressed video data, which is used to generate the video signal for the advertisement from the timer tₙ₋ₓ to tₙ.

Because the data from the ending segment 210b is uncompressed video data, the data from the ending segment 210b can be provided to the renderer 240 without first being decompressed by the decoder 230. Thus, during the time tₙ₋ₓ to tₙ, the decoder 230 is not needed for the advertisement data. Instead, while the uncompressed advertisement data 210b is being provided to the renderer, the decoder 240 is used to decode the broadcast feed 205.

The length of the ending segment 210b (tₙ−tₙ₋ₓ) is long enough such that the broadcast feed 205 will provide another key frame before playing of the advertisement ends. Encountering the key frame in the broadcast feed 205 enables the viewing device 164 to re-synchronize to the broadcast feed 205. The decoder 230, upon receiving the key frame, begins decompressing the broadcast feed 205, generating producing uncompressed video data, and provides the data to the renderer 240. At the end of the advertisement (at time tₙ), the renderer 240 provides the uncompressed video data as a video signal to the video display 250. Thus, the viewer does not experience a blank television screen or a frozen last frame of the advertisement at the end of the advertisement.

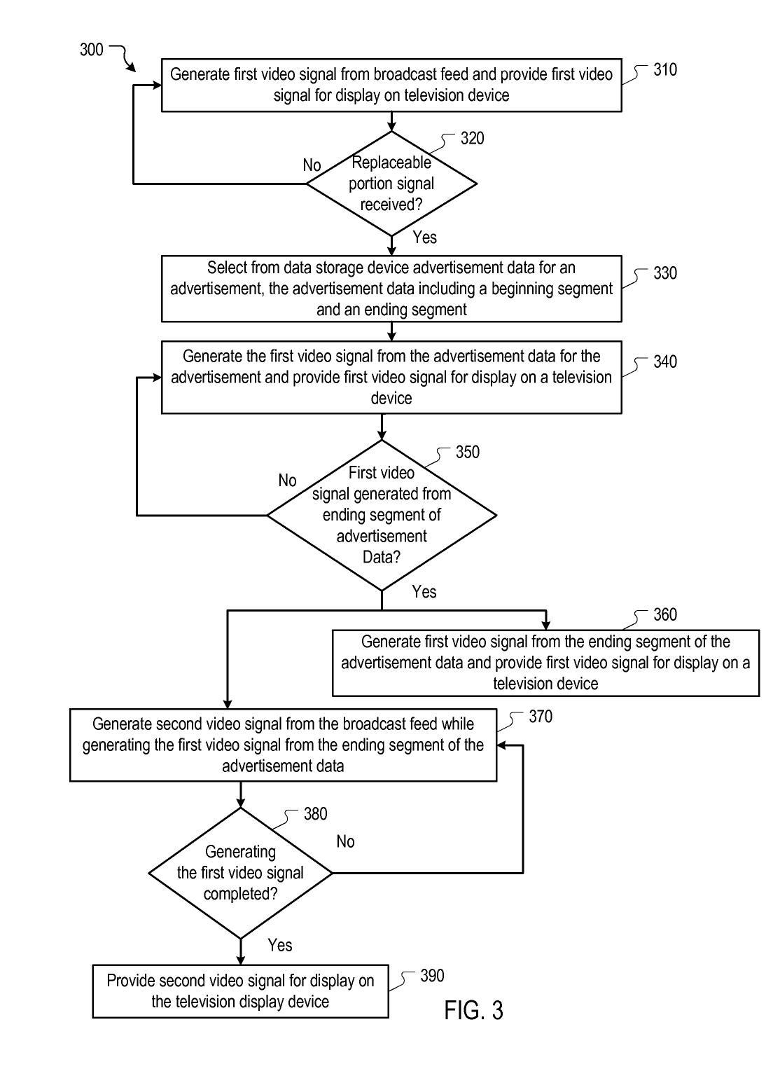

FIG. 3 is a flow chart diagram of an example process 300 for transitioning from an addressable advertisement to a broadcast feed. The process 300 can be implemented in a viewing device 164. The viewing device 164 generates a first video signal from a broadcast feed for display on a television device. In response to a signal indicating a replaceable portion in the broadcast feed, the viewing device 164 accesses locally stored advertisement data and generates a first video signal of an addressable advertisement for display on the television device. Upon detecting the generation of the first video signal from the ending segment of the addressable advertisement data, the viewing device 164 generates a second video signal from the broadcast feed while still providing the first video signal for display on the television device. The second video signal is provided for display on the television device at the end of the advertisement data, avoiding a blank screen or a frozen image screen. In operation, the viewing device 164 generates a first video signal from the broadcast feed (310). The first video signal is provided for display on a television device. The viewing device can detect a signal in the broadcast feed indicating replaceable content. Until there is a signal indicating a replaceable portion (320), the viewing device 164 continues to generate the first video signal from the broadcast feed and provides the first video signal to the television device.

In response to the signal indicating a replaceable portion in the broadcast feed, the viewing device 164 selects advertisement data for an addressable advertisement (330). The advertisement data is selected from the data storage device 168, e.g., a memory of the viewing device 164. The advertisement data has a beginning segment and an ending segment.

The viewing device 164 generates the first video signal from the advertisement data (340). The first video signal is provided for display on a television device. Generating the first video signal from the advertisement data has the side effect of causing the viewing device 164 to lose synchronization with the broadcast feed. While generating the first video signal, the viewing device 164 monitors what segment of the advertisement data the first video signal is generated from (350).

The viewing device 164 generates a second video signal upon detecting that the first video signal is generated from the ending segment of the advertisement data (370). The second video signal is generated from the broadcast feed. Until the advertisement is finished, the first video signal is still provided for display on the television device so that the entire advertisement is presented on the television device.

To generate the second video signal, the viewing device 164 processes a key frame that is received from the broadcast feed during the time the first video segment is being generated from the ending segment of the advertisement data. As described later, the ending segment of the advertisement data is long enough such that the viewing device 164 will receive a key frame before the end of the advertisement. This permits the viewing device to decode and generate the second video signal from the broadcast feed.

At the end of the advertisement (380), the second video signal is provided for display on the television display device (390). Because the viewing device 164 has received the key frame and is decoding the broadcast feed before switching to the second video signal, switching to the second video signal does not cause a blank screen or frozen screen on the television device.

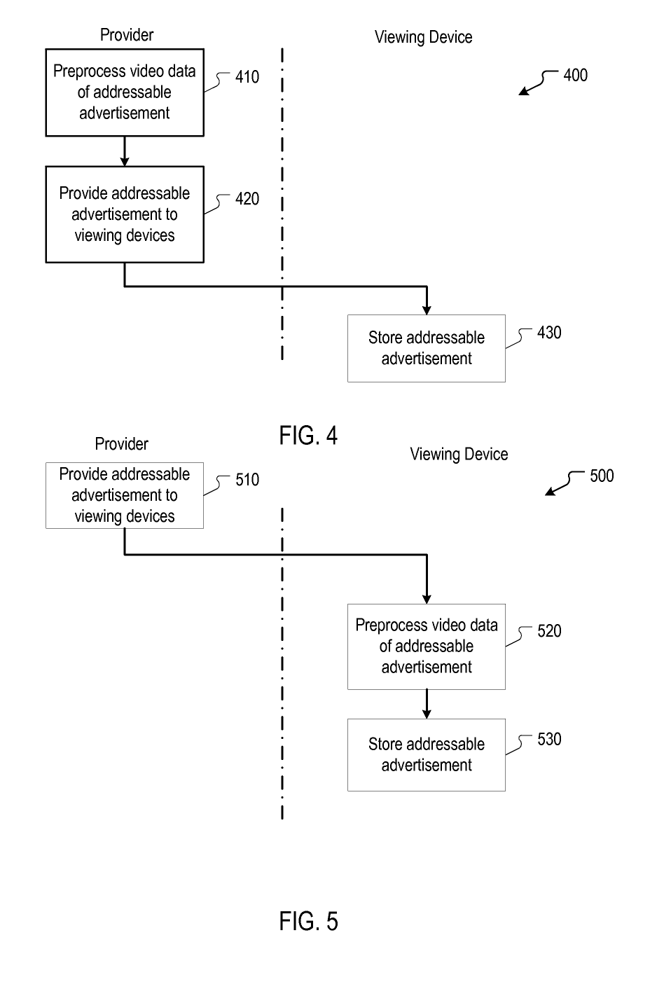

Typically, advertisement data are data encoded according to a video encoding standard. If an advertisement is to be provided to a viewing device as an addressable advertisement, the ending segment of the advertisement data for the advertisement is converted to decompressed video data. This conversion can occur either before the advertisement data are provided to the viewing device 164, which is described with reference to FIG. 4, or after the advertisement data are provided the to viewing device 164, which is described with reference to FIG. 5.

FIG. 4 is a flow chart of an example process 400 for providing addressable advertisement data to a viewing device. In the process 400, advertisement data that consists of encoded data is preprocessed to generate the ending segment, i.e., a portion of the advertisement data is decoded to generate the ending segment, before the advertisement data are provided to a viewing device. While the process 400 may result in additional bandwidth requirements for delivering the advertisements to the viewing devices, viewing device resources are conserved, as the viewing devices are not required to decode the ending segments. The process 400 can be implemented in a data processing apparatus of the provide 160 or the advertising system 105.

The process 400 preprocesses the video data of the addressable advertisement before distributing the advertisement to the viewing devices (410). The pre-processing step includes selecting a first segment of the advertisement data and an ending segment of the addressable advertisement data. The first segment and the ending segment of the advertisement data do not overlap and each store a portion of the advertisement. The data of the ending segment are decompressed and stored ad uncompressed video data.

The length of the ending segment of the advertisement data is selected based upon the keyframe periodicity of the broadcast feed. The length of the ending segment is such that a viewing device 164 will be able to synchronize and decode a broadcast feed while during generating a video signal from the ending segment. For example, the key frame periodicity for standard-definition television is approximately 0.5 seconds. Accordingly, the length of an ending segment for an addressable advertisement in standard-definition television will be at least 0.5 seconds in presentation duration. The length of the ending segment can also be greater than the key frame periodicity to increase the likelihood that the broadcast feed will be successfully decoded by the end of the presentation of the advertisement (e.g., to account for errors, garbled transmission data, etc.).

The description above applies when the advertisement data are stored in compressed form. If the advertisement data are stored as uncompressed data, then the selected first segment is compressed as part of the preprocessing. The compressed first segment forms the beginning segment of the advertisement data

The process provides the advertisement data to the viewing devices (420). For example, for viewing devices that are associated with targeted demographics of a particular addressable advertisement receive the advertisement data for the advertisement. The data may be provided at certain times of day, e.g., when the viewing device 164 is not being used (such as during the early morning hours), or the data may be provided with the broadcast feed. The data are then stored in the viewing devices (430).

FIG. 5 is a flow chart of an example process 500 for providing addressable advertisement data to a viewing device. In the process 500, advertisement data that consists of encoded data is preprocessed to generate the ending segment, i.e., a portion of the advertisement data is decoded to generate the ending segment, after the advertisement data are provided to a viewing device. The process 500 thus reduces the bandwidth required to provide addressable advertisement data to a viewing device.

The process 500 provides the advertisement data to the viewing devices (510). For example, for viewing devices that are associated with targeted demographics of a particular addressable advertisement receive the advertisement data for the advertisement. The data may be provided at certain times of day, e.g., when the viewing device 164 is not being used (such as during the early morning hours), or the data may be provided with the broadcast feed.

The process 500 preprocesses the video data of the addressable advertisement (520). The pre-processing step includes selecting a first segment of the advertisement data and an ending segment of the addressable advertisement data. The first segment and the ending segment of the advertisement data do not overlap and each store a portion of the advertisement. The data of the ending segment are decompressed.

The process 500 stores the addressable advertisement (530). For example, the two segments of the advertisement data, the latter being decompressed data, are stored in a memory store of the viewing device 164.

The apparatus, methods, flow diagrams, and structure block diagrams described in this patent document may be implemented in computer processing systems including program code comprising program instructions that are executable by the computer processing system. Other implementations may also be used. Additionally, the flow diagrams and structure block diagrams described in this patent document, which describe particular methods and/or corresponding acts in support of steps and corresponding functions in support of disclosed structural means, may also be utilized to implement corresponding software structures and algorithms, and equivalents thereof

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks. The processor and the memory can be supplemented by, or incorporated in, special purpose logic circuitry.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method implemented in a viewing device, comprising:
generating a first video signal from a broadcast feed;
providing the first video signal for display on a television display device;
receiving a signal in the broadcast feed indicating the broadcast feed contains a replaceable portion, the replaceable portion indicating a portion of the received broadcast feed that can be replaced with a video signal generated from data stored locally at the viewing device;
in response to receiving the signal:
selecting, from a data storage device, advertisement data for an advertisement, the advertisement data including a beginning segment of compressed video data and an ending segment of uncompressed video data;
generating the first video signal from the advertisement data for the advertisement;
monitoring for generation of the first video signal from the ending segment of the advertisement data;
in response to monitoring the generation of the first video signal from the ending segment of the advertisement data:
generating a second video signal from a broadcast feed while generating the first video signal from the ending segment of the advertisement data; and
providing the second video signal for display on the television display device after generating the first video signal from the advertisement data is completed.

2. The method of claim 1, wherein a duration of the ending segment is at least equal to the periodicity of a key frame in an encoding scheme that is used to encode the broadcast feed.

3. The method of claim 2, wherein the key frame is an I-frame.

4. The method of claim 1, wherein the advertising data is transmitted to the viewing device in the broadcast feed.

5. The method of claim 1, wherein the broadcast feed is transmitted over an Internet Protocol network.

6. The method of claim 1, wherein selecting advertisement data for an advertisement comprises selecting advertisement data for an advertisement based on demographics of associated with the viewing device.

7. The method of claim 1, wherein a viewing device detects a keyframe in the broadcast feed during a duration of generating the first video signal from the ending segment of the advertisement.

8. The method of claim 1, further comprising:
receiving compressed data for the advertisement, the compressed data received in the broadcast feed;
selecting a first segment of the compressed data and a second segment of the compressed data, the second segment of the compressed data being data that are used to generate an ending portion of the advertisement that is of a duration at least equal to a key frame periodicity of an encoding scheme used to encode the compressed data;
decompressing the compressed data of the ending segment;
storing the compressed data of the first segment as the beginning segment; and
storing the decompressed data of the second segment as the ending segment.

9. A method, comprising:
receiving compressed data for the advertisement;
selecting a first segment of the compressed data and a second segment of the compressed data, the second segment of the compressed data being data that are used to generate an ending portion of the advertisement that is of a duration at least equal to a key frame periodicity of an encoding scheme used to encode the compressed data;
decompressing the compressed data of the ending segment;
storing the compressed data of the first segment as a beginning segment of advertisement data; and
storing the decompressed data of the second segment as an ending segment of advertisement data.

10. The method of claim 9, further comprising:
providing the advertisement data to a plurality of viewing devices;
transmitting a broadcast feed including a signal indicating the broadcast feed contains a replaceable portion that can be replaced by an advertisement generated from the advertisement data.

11. A viewing device, comprising:
a data storage device storing advertisement data for one or more advertisements, and for each advertisement the advertisement data includes a beginning segment and an ending segment; and
signal processing circuitry in data communication with the data storage device and that performs operations comprising:
generating a first video signal from a broadcast feed;
providing the first video signal for display on a television display device;
receiving a signal in the broadcast feed indicating the broadcast feed contains a replaceable portion, the replaceable portion indicating a portion of the received broadcast feed that can be replaced with a video signal generated from data stored locally at the viewing device;
in response to receiving the signal:
selecting, from a data storage device, advertisement data for an advertisement, the advertisement data including a beginning segment of compressed video data and an ending segment of uncompressed video data;
generating the first video signal from the advertisement data for the advertisement;
monitoring for generation of the first video signal from the ending segment of the advertisement data;
in response to monitoring the generation of the first video signal from the ending segment of the advertisement data:
generating a second video signal from a broadcast feed while generating the first video signal from the ending segment of the advertisement data; and
providing the second video signal for display on the television display device after generating the first video signal from the advertisement data is completed.

12. The viewing device of claim 11, wherein a duration of the ending segment is at least equal to the periodicity of a key frame in an encoding scheme that is used to encode the broadcast stream

13. The viewing device of claim 11, wherein the signal processing circuitry performs operations further comprising:
receiving compressed data for the advertisement;
selecting a first segment of the compressed data and a second segment of the compressed data, the second segment of the compressed data being data that are used to generate an ending portion of the advertisement that is of a duration at least equal to a key frame periodicity of an encoding scheme used to encode the compressed data;
decompressing the compressed data of the ending segment;
storing the compressed data of the first segment as a beginning segment of advertisement data; and
storing the decompressed data of the second segment as an ending segment of advertisement data.

14. The viewing device of claim 13, wherein signal processing circuitry comprises a decoder that is used to generate the first video signal and the second video signal.

15. A system, comprising:
a data processing apparatus; and
a memory storage apparatus storing instruction that when executed by the data processing apparatus cause the data processing apparatus to perform operations comprising:
receiving compressed data for an advertisement, the compressed data received in a broadcast feed;
selecting a first segment of the compressed data and a second segment of the compressed data, the second segment of the compressed data being data that are used to generate an ending portion of the advertisement that is of a duration at least equal to a key frame periodicity of an encoding scheme used to encode the compressed data;
decompressing the compressed data of the ending segment;
storing, in the memory storage apparatus, the compressed data of the first segment as a beginning segment of advertisement data; and
storing, in the memory storage apparatus, the decompressed data of the second segment as an ending segment of advertisement data.

16. The system of claim 15, wherein the data processing apparatus further comprises:
signal processing circuitry in data communication with the memory storage apparatus and that performs operations comprising:
generating a first video signal from the broadcast feed;
providing the first video signal for display on a television display device;
receiving a signal in the broadcast feed indicating the broadcast feed contains a replaceable portion;
in response to receiving the signal:
selecting, from the memory storage apparatus, advertisement data for an advertisement, the advertisement data including a beginning segment of compressed video data and an ending segment of uncompressed video data;
generating the first video signal from the advertisement data for the advertisement;
monitoring for generation of the first video signal from the ending segment of the advertisement data;
in response to monitoring the generation of the first video signal from the ending segment of the advertisement data:
generating a second video signal from a broadcast feed while generating the first video signal from the ending segment of the advertisement data; and
providing the second video signal for display on the television display device after generating the first video signal from the advertisement data is completed.

17. The system of claim 16, wherein the signal processing circuitry comprises a decoder that is used to generate the first video signal and the second video signal.

18. The system of claim 15, wherein the key frame is an I-frame.

19. The system of claim 16, wherein selecting advertisement data for an advertisement comprises selecting advertisement data for an advertisement based on demographics of associated with the viewing device.
